(19) United States
(12) Patent Application Publication
(10) Pub. No.: US 2007/0198281 A1
(43) Pub. Date: Aug. 23, 2007

(54) Contact reminder apparatus, system, and method

(76) Inventors: Michael N. Abernethy JR., Pflugerville, TX (US); Kulvir S. Bhogal, Fort Worth, TX (US); Travis M. Grigsby, Austin, TX (US); Alexandre Polozoff, Bloomington, IL (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/360,904

(22) Filed: Feb. 23, 2006

(51) Int. Cl. G06Q 99/00

(52) U.S. Cl. 705/1

(57) ABSTRACT

A contact reminder apparatus, system and method are provided. The illustrative embodiments provide a mechanism for providing contact reminder messages to a user based on communications with contacts from a variety of different communication devices. The illustrative embodiments synchronize communication logs and contacts from communication devices that may be of the same or different types and use the synchronized communication logs to determine whether to reset contact reminder counters that are used to determine whether to send a contact reminder message to a user. A user may designate preferred types of communication for each contact and may have the contact reminder counters automatically adjusted based on such preferences and whether or not a preferred type of communication was last used to communicate with a contact. Moreover, contact reminders may be sent to communication devices determined to provide the communication type corresponding to the communication type specified in the contact reminder.

### BACKGROUND

1. Technical Field

The present application relates generally to an improved communication apparatus, system, and method. More specifically, the present application is directed to an apparatus, system and method for providing contact reminders to communication devices.

2. Description of Related Art

Often it is beneficial for an individual to stay in touch with a particular contact so as to continue to foster a relationship with that contact. Such situations may arise, for example, when fostering a business relationship between an individual and a client. Moreover, such situations may arise through personal relationships, such as with relatives and other loved ones.

U.S. Patent Application Publication 2003/0215077, entitled “Call-to-Make Reminder System,” published Nov. 20, 2003, describes one exemplary system for reminding a user of calls that the user should make to prevent protracted negligence. With the system described in this publication, a telephone service server generates a call-to-make reminder page based on an urgency of a reminder. The urgency of the reminder is determined by multiplying a non-contact period from the last call made to the person, as derived from communication logs, by a level of necessity to maintain a close relationship, as derived from profiles of the person to contact. While this system provides a reminder to make a call to a particular person, the system is limited to telephone communication, limited in the types of reminders that are provided, and limited in the manner by which it determines whether a reminder page is to be sent.

Other mechanisms for reminding users of events include calendar systems, such as is provided by Microsoft Outlook, in which users may enter event descriptions which are associated with calendar entries. With such calendar systems, based on reminder settings for the event, e.g., 3 hours before the event, a reminder window may be displayed to the user to identify the occurrence of the event. In addition, a user may specify a reoccurring event, such as an event that occurs every Friday, an event that occurs every first Monday of the month, and the like.

While such calendar systems allow a user to enter reoccurring events and obtain reminder notices prior to the event, the reoccurrence of the events is not predicated on users satisfying event criteria. In other words, the calendar based systems are merely informative and do not actively monitor a user's use of the system in which it is running to determine if the user satisfies event criteria. Furthermore, such calendar based systems typically do not determine the reoccurrence of an event dynamically based on a history of user's use of the system. Moreover, such calendar based systems are not typically concerned with dynamically determining the reoccurrence of events based on types of communications the user may use to communicate with a contact.

### SUMMARY

In view of the above, it would be beneficial to have an apparatus, system and method for providing contact reminders that takes into account the various types of communication that may be used to contact individuals as well as the elapsed time between when one of these various types of communication were used to contact the individuals and a present time. Moreover, it would be beneficial to have an apparatus, system and method for allowing a user to place various emphasis on the various types of communication so as to provide a preference for various types of communication when contacting individuals. The illustrative embodiments provide such an apparatus, system and method.

With the illustrative embodiments, one or more communication monitors are provided on one or more communication devices and/or systems of the same or different types, e.g., a wireless telephone, landline telephone, electronic mail device or system, an instant messaging device or system, and the like. In one illustrative embodiment, the communication monitors may be implemented as one or more daemon applications that are executed by processors of the communication devices. Alternatively, the communication monitors may be embodied in hardware, such as a hardware chip, firmware, or the like. Moreover, the communication monitors may be embodiment in a combination of hardware and software.

Each of the one or more communication devices/systems are synchronized with one another via the communication monitor(s) with regard to contact reminders. Essentially, the communication monitor(s) maintain a list of contact reminders comprising pointers to contacts and countdown timers for each contact, the countdown timers being configured according to user preferences. The communication monitor(s) check the list at predetermined time intervals to determine if any contact reminder notices are to be output to a user. The contact reminder notice serves to inform the user that it is time to communicate with a particular party due to an elapsed time from a previous communication with that party having met predetermined criteria.

One or more communication monitors further maintain a data structure defining the contact information for the communication devices/systems that are to be synchronized by the communication monitors. In this way, when a communication is performed with a particular party using one of the communication devices/systems, all other communication devices/systems that are to be synchronized are informed of the communication using the contact information so that they may be properly synchronized.

The one or more communication monitors further maintain a rules database having rules for determining whether a particular communication qualifies as a valid communication with a particular party. For example, various rules may be established for determining when a telephone communication is more representative of the user leaving a voicemail message rather than speaking directly with the party, a busy line condition being experienced, an automated return electronic mail message being returned, an instant messaging communication session being representative of an actual conversation, and the like. Since the communication monitor operates automatically in a background, these rules are established for automatically guiding the behavior of the communication monitor so as to avoid requiring user interaction.

The rules database may further comprise rules for determining how to modify the predetermined criteria and/or countdown timers for a next iteration of the communication monitor with regard to a particular party. For example, various preferences for different types of communication may be established in the rules database such that when a less preferred communication type is used to communicate with a party, the countdown timer and/or the predetermined criteria may be adjusted so as to promote more preferred types of communication.

Moreover, in one illustrative embodiment, different countdown timers and predetermined criteria may be used for different types of communication with the same party. Thus, a single party, or contact, may have multiple countdown timers and predetermined criteria associated with it, one or more for each type of communication. In this way, the rules may be used to adjust individual ones of these countdown timers and predetermined criteria based on preferences set by the user and the type of communication last used to communicate with the party.

In one illustrative embodiment, a method, in a data processing system, for sending contact reminder messages to one or more communication devices of a synchronization group is provided. The method may comprise establishing a synchronization group, wherein the synchronization group comprises at least two communication devices, and generating one or more contact reminder counters based on contact reminder preferences for the synchronization group. The method may further comprise sending contact reminder messages to at least one communication device of the synchronization group in response to at least one of the one or more contact reminder counters reaching a predetermined value. The first communication device of the at least two communication devices may communicate using a first communication type and a second communication device of the at least two communication devices may communicate using a second communication type that is different from the first communication type.

The method may further comprise generating a contact reminder preferences data structure for the synchronization group that comprises the contact reminder preferences for the synchronization group. The contact reminder preferences data structure may comprise, for each contact of a plurality of contacts, associated contact reminder preferences for generating contact reminders for that particular contact in the plurality of contacts. The contact reminder preferences may specify at least one contact time interval for communicating with an associated contact and a preferred communication type for communicating with the associated contact. The contact reminder preferences may further specify at least one other communication type for communicating with the associated contact other than the preferred communication type. The method may generate one or more contact reminder counters based on contact reminder preferences by generating, for the associated contact, two or more contact reminder counters based on the preferred communication type and the at least one other communication type.

The method may send contact reminder messages to the at least one communication device of the synchronization group in response to at least one of the one or more contact reminder counters reaching a predetermined value by determining a communication type associated with a contact reminder counter that reached the predetermined value and determining communication devices of the synchronization group providing communications using the determined communication type. Contact reminder messages may be sent to communication devices of the synchronization group that provide communications using the determined communication type.

The method may further comprise detecting initiation of a communication to a contact by a communication device in the synchronization group and monitoring the communication to determine if a valid communication was conducted with the contact based on an application of one or more rules specifying criteria of a valid communication to characteristics of the monitored communication. Moreover, the method may reset at least one of the one or more contact reminder counters to a value corresponding to a desired contact time interval for the contact, as specified in the contact reminder preferences, in response to the communication being determined to be a valid communication. Furthermore, the method may cancel contact reminder messages being output on communication devices of the synchronization group in response to the communication being determined to be a valid communication.

The method may send contact reminder messages to the at least one communication device of the synchronization group in response to at least one of the one or more contact reminder counters reaching a predetermined value by checking the one or more contact reminder counters to determine if any one of the contact reminder counters reaches the predetermined value and sending a contact reminder message specifying a contact associated with a contact reminder counter that reached the predetermined value and a preferred communication type for communicating with the contact. Moreover, the method may generate, for each contact reminder message, a “to do” list entry corresponding to the contact reminder message in at least one communication device of the synchronization group.

In another illustrative embodiment, a computer program product comprising a computer useable medium having a computer readable program for sending contact reminder messages to one or more communication devices of a synchronization group is provided. The computer readable program, when executed on a computing device, may cause the computing device to perform various ones of the operations, and/or combinations of the operations, described above with regard to the method illustrative embodiment.

In yet another illustrative embodiment, a communication apparatus is provided that includes a processor and a memory coupled to the processor. The memory may contain instructions which, when executed by the processor, cause the processor to perform various ones of the operations, and/or combinations of the operations, described above with regard to the method illustrative embodiment.

These and other features and advantages of the present invention will be described in, or will become apparent to those of ordinary skill in the art in view of the following detailed description of the exemplary embodiments of the present invention.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a system of communication networks and communication devices in which exemplary aspects of the illustrative embodiments may be implemented;

FIG. 2 is an exemplary block diagram of the primary operational elements of a communication device/system in accordance with one illustrative embodiment;

FIG. 3 is an exemplary block diagram illustrating the use of a communication log and contact reminder preferences to update contact reminder information and generate contact reminder messages in accordance with one illustrative embodiment;

FIG. 4 is a flowchart outlining an exemplary operation of a communication monitor module for establishing a synchronization group and contact reminder preferences in accordance with one illustrative embodiment;

FIG. 5 is a flowchart outlining an exemplary operation of a communication monitor module when updating a communication log and contact reminder counters in accordance with one illustrative embodiment; and

FIG. 6 is a flowchart outlining an exemplary operation of a communication monitor module when generating a contact reminder message and/or “to do” list entry in accordance with one illustrative embodiment.

### DETAILED DESCRIPTION OF THE PREFERRED EMBODIMENTS

The illustrative embodiments provide an apparatus, system and method of monitoring communications from various synchronized communication devices so as to provide contact reminders to a user. These contact reminders are provided to the user in accordance with preferences set by the user and the communications between the user and the various contacts. The communications may be of various types including telephone communications, instant messages, electronic mail messages, pages, and the like.

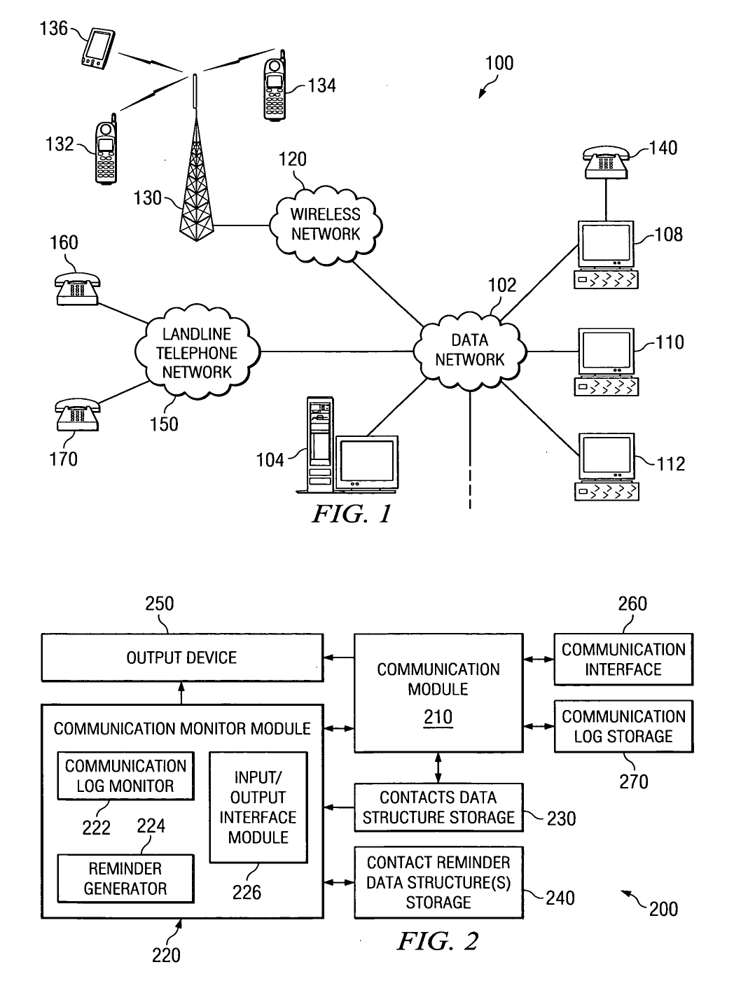

FIG. 1 is an exemplary diagram of a system of communication networks and communication devices in which exemplary aspects of the illustrative embodiments may be implemented. As shown in FIG. 1, the system 100 includes a plurality of networks 102, 120 and 150. In particular, a data network 102, wireless network 120, and landline telephone network 150 are depicted. It should be noted that while only these three types of networks are depicted in FIG. 1, the present invention is not limited to only these types of networks or require the inclusion of all of these types of networks. Other types of communication networks may be used in addition to or in replacement of one or more of the depicted networks 102, 120 and 150 without departing from the spirit and scope of the present invention.

The data network 102 may comprise one or more networks of the same or different types. For example, the data network 102 may comprise one or more local area networks (LANs), wide area networks (WANs), the Internet, and the like. Similarly, the wireless network 120 and landline telephone network 150 may comprise one or more networks of the same or different types. Essentially, any number and type or combination of types of communication networks may be used with the illustrative embodiments without departing from the spirit and scope of the present invention.

Each network 102, 120, and 150 has one or more communication devices coupled to it through either wired or wireless communication links. For example, the data network 102 has a server 104 and client devices 108-112 coupled to it via communication links generally known in the art. In addition, client device 108 has an associated telephone communication device 140 which communicates with other wired or wireless telephone devices via the client device 108 and data network 102, e.g., via Internet telephony. The client devices 108-112 and/or telephone communication device 140 preferably have the capability to perform one or more of voice telephone communications, electronic mail message communications, instant text message communications, and the like.

Wireless network 120 has a plurality of wireless communication devices 132, 134 and 136 which communicate via the wireless network 120 through wireless-communication point 130, e.g., a cellular base station, wireless access point, or the like. The wireless communication devices 132, 134 and 136 may be, for example, wireless telephones, personal digital assistants, pagers, or the like. The wireless communication devices 132, 134 and 136 preferably have the capability to perform one or more of voice telephone communications, electronic mail message communications, instant text message communications, and the like.

The landline telephone network 150 has a plurality of wired or landline communication devices 160 and 170 coupled to it via wired links as are generally known in the art. As with the other communication devices described above, the landline telephone devices 160 and 170 preferably have the capability to perform one or more of voice telephone communications, electronic mail message communications, instant text message communications, and the like.

The various wireless communication devices 132, 134 and 136 and wired communication devices 108-112, 140, 160, and 170 may maintain data structures identifying contact information for a user of the communication devices as well as a communication log that lists the communications recently performed or attempted. Alternatively, rather than storing such contact and communication log information in the communication devices themselves, such information may be stored in centralized servers, intelligent switches, or the like, of the various networks 102, 120, and 150. The contact information may include contact names, telephone number(s), electronic mail addresses, instant messaging addresses, and the like. The communication log may include an identifier of the contact with which the communication was performed or attempted, a time of the communication or communication attempt, a duration of the communication or communication attempt, and the like.

As mentioned above, the illustrative embodiments provide a mechanism for providing contact reminders to a user based on communications performed by a variety of different types of communication devices and preferences established by the user. In one illustrative embodiment, control of the sending of contact reminders is performed from a centralized location, such as from server 104 in the data network 102 of FIG. 1. In another illustrative embodiment, the control of the sending of contact reminders is performed in a distributed manner, such as in each communication device associated with a user. For purposes of this description, it will be assumed that a distributed embodiment is being utilized. However, it will be appreciated that the same operations may be performed from a centralized location which synchronizes the various communication devices without departing from the spirit and scope of the present invention.

With the illustrative embodiments, one or more communication monitors are provided on the one or more communication devices and/or systems of the same or different types. In one illustrative embodiment, the communication monitors may be implemented as one or more daemon applications that are executed by processors of the communication devices/systems. Alternatively, the communication monitors may be embodied in hardware, such as a hardware chip, firmware, or the like.

Each of the one or more communication devices/systems are synchronized with one another via the one or more communication monitors with regard to contact reminders. The one or more communication monitors maintain a list of contact reminders comprising pointers to contacts and countdown timers for each contact, the countdown timers being configured according to user preferences. The one or more communication monitors check the list at predetermined time intervals to determine if any contact reminder notices are to be output to a user. The contact reminder notice serves to inform the user that it is time to communicate with a particular party due to an elapsed time from a previous communication with that party having met predetermined criteria.

The one or more communication monitors may further maintain a contact data structure defining the contact information for the communication devices/systems that are to be synchronized by the communication monitors. In this way, when a communication is performed with a particular party using one of the communication devices/systems, all other communication devices/systems that are to be synchronized are informed of the communication using the contact information so that they may be properly synchronized.

The one or more communication monitors further maintain a rules database having rules for determining whether a particular communication qualifies as a valid communication with a particular party. For example, various rules may be established for determining when a telephone communication is more representative of the user leaving a voicemail message rather than speaking directly with the party, a busy line condition being experienced, an automated return electronic mail message being returned, an instant messaging communication session being representative of an actual conversation, and the like. Since the communication monitors may operate automatically in a background, these rules are established for automatically guiding the behavior of the communication monitors so as to avoid requiring user interaction.

The rules database may further comprise rules for determining how to modify the predetermined criteria and/or countdown timers for a next iteration of the communication monitor with regard to a particular party. For example, various preferences for different types of communication may be established in the rules database such that when a less preferred communication type is used to communicate with a party, the countdown timer and/or the predetermined criteria may be adjusted so as to promote more preferred types of communication.

Moreover, in one illustrative embodiment, different countdown timers and predetermined criteria may be used for different types of communication with the same party. Thus, a single party, or contact, may have multiple countdown timers, e.g., one or more for each type of communication, and predetermined criteria associated with that party in a countdown timer data structure, which is generated based on the preferences in the contact data structure and the application of rules from the rules database. In this way, the rules may be used to adjust individual ones of these countdown timers and predetermined criteria based on preferences set by the user and the type of communication last used to communicate with the party.

As an example, assume that a user of a plurality of communication devices 110, 134, 160 and 170 wishes to stay in contact with a particular customer in order to foster the business relationship with that customer. The user may establish a group of communication devices by specifying each communication device and its associated contact information, e.g., telephone number, electronic mail address, instant messaging address, etc. This group of communication devices becomes a synchronization group in which changes to communication log, contact reminder, and contact information are synchronized with each communication device that is part of that synchronization group. This synchronization group data structure may be distributed to each communication device in the synchronization group.

Upon distributing the synchronization group data structure to each of the communication devices, the communication monitors on the various communication devices proceed to perform a synchronization operation with the other communication devices. This synchronization operation involves sending the contact information, communication log information, and contact reminder information of the communication device to each of the other communication devices in the synchronization group. Each communication device in the synchronization group communicates this information with each other communication device initially and the communication monitors of each communication device operate to update their own local copy of this information.

Each communication monitor contains logic for performing such updates and resolving any conflicts between information from various communication devices. For example, the most recent version of conflicting information may be used to overwrite previous versions of the information, e.g., contact information, contact reminder preference information, communication log information, and the like. In this way, each communication device in the synchronization group has the same contact list data structure, contact reminder information data structure, and communication log data structure.

After this initial synchronization, the communication devices of the synchronization group only communicate updates to contact, contact reminder, and communication log information to the other communication devices. If additional communication devices are added to the synchronization group, the initial synchronization operation may be performed with regard to the newly added communication devices.

The user may establish contact reminder preferences for one or more contacts in the contact list data structure of the communication devices. The contact reminder preferences may identify, for example, the particular contact and the desired time interval in which the user wishes to communicate with the contact. In addition, the contact reminder preferences may identify a ranked preference for the types of communication that are to be used with this particular contact. Thus, for example, for one particular contact, telephone communication may be preferred while with another contact, electronic mail or instant text messages may be preferred. In this way, different types of communication may be weighted differently for each contact. Alternatively, a plurality of different desired time intervals for each type of communication may be established as part of the contact reminder preferences.

The contact reminder preferences for the one or more contacts are used to establish a contact reminder data structure. Entries in the contact reminder data structure include a pointer to a corresponding contact and one or more countdown timers for a time interval from a last communication with the corresponding contact. When a countdown timer for the contact reaches zero, for example, a contact reminder is output by one or more of the communication devices of the synchronization group so as to inform the user that he/she should communicate with the identified contact. In one illustrative embodiment in which there are separate countdown timers for each type of communication, the contact reminder may be output on communication devices that are capable of performing the type of communication associated with the countdown timer. Thus, if a countdown timer associated with electronic mail communication reaches zero, a contact reminder may be output on a computing device, personal digital assistant, and/or electronic mail enabled telephone indicating that the user should send an electronic mail message to the particular contact.

The contact reminder message may identify the contact with which communication is to be made as well as the type of communication that is preferred based on the particular countdown timer that expired and/or the preferences established by the user. The contact reminder message may be periodically output to the user until a communication is made with the identified contact.

A communication to a contact is identified based on the destination information of the communication, e.g., the dialed telephone number, the “to” field of an electronic mail message or instant text message, or the like. The detection of a communication to a contact may be performed automatically by the communication monitor as a background operation, i.e. without being perceivable to the user. Thus, from the viewpoint of the user, the operation of the communication device has not changed. Once a contact is identified in a communication, the communication is monitored to determine if it qualifies as an actual communication or just a communication attempt.

The communication monitor includes rules for defining when a communication attempt qualifies as an actual communication. These rules operate to differentiate between actual conversations with a contact and communication attempts that do not result in an actual conversation with the contact. Thus, there are rules for defining the difference between an actual voice conversation with a contact and leaving a voicemail message, a busy signal being encountered, or a short communication indicative of the contact not being available, for example. Such rules may involve determining if a total elapsed time of a communication is less than a particular threshold, detection of a busy signal being received, detection of a voicemail system indicator, and the like.

Once the communication is made with the identified contact, the countdown timer(s) are reset. In one illustrative embodiment, all countdown timers associated with the contact may be reset. In another illustrative embodiment, only the countdown timer associated with the type of communication performed with the contact is reset. The countdown timer or timers are reset to an initial value determined based on the preferences set by the user regarding the time interval between communications with the contact.

In addition to resetting the countdown timer(s), the communication monitor may perform automatic reminder cancellation/cleanup operations in response to a communication having been conducted with the identified contact. For example, if the user of the communication device had previously received a contact reminder that he/she did not close or appropriately handle, such contact reminders may be automatically removed from the output of the communication devices in the synchronization group. In such a case, an appropriate control message may be distributed to the communication devices in the synchronization group to remove any manifestations of contact reminders currently being output by the communication devices. The communication monitor may perform such operations in the background without interaction from the user of the communication devices.

In another illustrative embodiment, based on preferences for different types of communication, once a communication is made with an identified contact, the countdown timers associated with other types of communication may be modified so as to promote the more preferred types of communication. For example, if a user communicates with the contact via electronic mail, and telephone communication is preferred, then the countdown timer associated with telephone communication may be modified so that it will expire faster than other types of communication. Similarly, the type of contact reminder message that is output may be modified based on the type of communication that was previously performed and the type of communication that is preferred.

Moreover, if only a single countdown timer is utilized, various weights, as determined from the user's preferences, of the other types of communication, other than the type of communication that was actually used previously to communicate with the contact, may be used to modify the countdown timer so that a communication reminder is output quicker than otherwise would normally be done. For example, if the communication was an electronic mail message and telephone communication is preferred, the countdown timer's initial value may be lowered so that the reminder is output quicker on the communication device(s) so as to promote telephone communication. This process may be repeated until a preferred communication type is used to communicate with the contact.

It should be noted that when the communication is performed, when countdown timers are reset or otherwise updated, or when other information used by the communication monitors is modified on one communication device, that communication device sends the modifications to the other communication devices so as to synchronize them. In this way, the communication devices are maintained synchronized.

It should further be noted that the communication monitor provides logic for handling modifications to the various data structures maintained and utilized by the communication monitor. For example, the communication monitor includes logic for automatically removing contact reminders that may be output by the communication devices in the synchronization group, contact counters, and the like, when the contact is removed from the contacts data structure of the synchronization group.

Moreover, the communication monitor contains logic for handling modifications to the communication preferences for a particular contact. For example, if a user deletes a preferred communication type from a contact reminder preferences data structure for a particular contact, the communication monitor contains logic for automatically adjusting the remaining communication preferences, if any, for that contact. Alternatively, or in addition to the automatic adjustment, the communication monitor may contain logic for outputting a message to the user indicating that the user is about to delete a contact's primary communication type and requesting if the user wishes to specify a different primary communication type.

Thus, from the above, it can be seen that the illustrative embodiments provide an apparatus, system and method for outputting contact reminders to a user based on communications performed with a contact using different types of communication. The particular types of communication used to communicate with a contact may be used to influence the manner by which such contact reminders are output. Moreover, preferences set by the user may be used to control such contact reminders and promote preferred communication types over other communication types. In addition, the various communication devices that may be utilized by the user are maintained in a synchronized manner with regard to the operation of the communication monitors.

FIG. 2 is an exemplary block diagram of the primary operational elements of a communication device/system in accordance with one illustrative embodiment. As shown in FIG. 2, the communication device 200 includes a communication module 210, a communication monitor 220, a contacts data structure storage 230, a contact reminder data structure storage 240, an output device 250, a communication interface 260, and a communication log storage 270. The communication module 210 performs all the necessary operations for establishing and controlling communications with other communication devices via the communication interface 260. Depending upon the particular communication device, the communication module 210 and communication interface 260 may be used to send/receive voice communications, text communications, or the like.

The output device 250 is a device for outputting information on the communication device 200. The output device 250 may be, for example, a display on the communication device 200, an audio output device, or the like. For example, if the communication device 200 is a wireless telephone, the output device 250 may be a liquid crystal display whereas if the communication device 200 is a personal computer, the output device 250 may be a computer monitor or the like.

The contacts data structure storage 230 stores information regarding the various contacts of the user, i.e. people and organizations with which the user communicates. As mentioned above, this contact information may include an identifier of the contact along with associated information for communicating with that contact, e.g., telephone number, electronic mail address, instant text messaging address, and the like.

The communication log storage 270 stores information regarding the various communications performed or attempted by the communication module 210. Such communication log information may include an identifier of the contact with which communication was performed or attempted, a time stamp of the communication or attempted communication, a duration of the communication or attempted communication, and the like.

In addition to the above, the communication device 200 includes a communication monitor 220 and a contact reminder data structure storage 240. The communication monitor 220 operates to perform the various functions of the illustrative embodiments based on information stored in the contact reminder data structure storage 240, the contacts data structure 230, and the communication log storage 270. The communication monitor 220 includes a communication log monitor 222, a reminder generator 224, and an output interface 226. The communication log monitor 222 monitors the communication log stored in the communication log storage 270 to identify communications performed or attempted to contacts in the contacts data structure 230. The communication log monitor 222 determines whether a communication performed or attempted, as identified in the communication log 270, is to a contact for which a contact reminder data structure entry has been established in the contact reminder data structure storage 240. If so, then the details of the communication are provided to the reminder generator 224 to update contact reminder information.

The reminder generator 224 controls the updating of contact reminder information in the contact reminder data structure and the generation of contact reminder messages. The reminder generator 224 may establish and maintain reminder counters based on the information stored in the contact reminder data structure storage 240 for one or more of the contacts identified in the contacts data structure 230. Based on information from the communication log storage 270, the reminder generator 224 may reset reminder counters. The resetting of reminder counters may further be performed based on preferences for communication types stored in the contact reminder data structure 240.

When one or more of the reminder counters for a contact reach a predetermined value, e.g., zero, then the reminder generator 224 may generate a contact reminder message that is output to the user via the output device 250. In addition, an item may be added to a “to do” list data structure that is maintained by the communication module 210, if the communication device 200 supports such “to do” lists. The reminder generator 224 may periodically output the contact reminder message via the output device 250 until a communication with the contact is detected from the communication log storage 270 or update information is received from another communication device via the communication interface 260 indicating that a communication to the contact was performed.

The communication monitor 220 further includes an interface module 226 through which contact reminder messages may be output and user input may be received. The user may provide preferences with regard to one or more contacts in the contacts data structure 230 for establishing contact reminder counters. As previously mentioned above, these preferences may involve associating pointers to contacts in the contacts data structure storage 230 with preferences as to one or more time intervals between communications with the associated contacts and, optionally, preferences as to which types of communication are to be used with the associated contact.

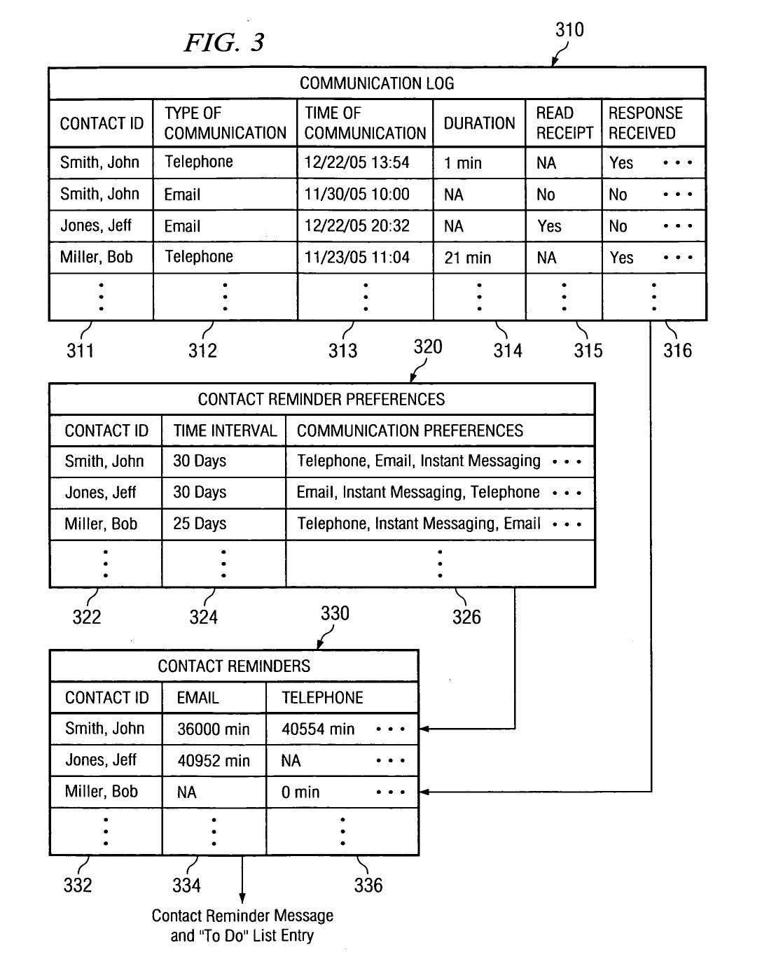

FIG. 3 is an exemplary block diagram illustrating the use of a communication log and contact reminder preferences to update contact reminder information and generate contact reminder messages in accordance with one illustrative embodiment. As shown in FIG. 3, a contact reminder preferences data structure 320 is generated based on user input for setting preferences regarding a time interval for remaining in contact with individual contacts 322 of a user's contacts data structure 230. In the depicted example, a single time interval 324 is shown as being established, however the present invention is not limited to such. Rather, different time intervals may be established for different types of communication to the same contact without departing from the spirit and scope of the present invention, as previously discussed.

In addition to setting time intervals 324 for communicating with a contact, a user may establish communication preferences 326 for each contact indicating the preferred manner by which the user should attempt to communicate with the contact. For example, as depicted, the preferred method for communicating with John Smith is to use the telephone whereas the preferred method for communication with Jeff Jones is to use electronic mail. Secondary communication preferences may further be specified to thereby generate a hierarchy of preferred communication types for each contact. This preferred hierarchy may be used to apply modifications to the time interval 324 when a less preferred method of communication is used to communicate with a contact.

A communication log data structure 310 is generated through the synchronization of the various communication devices of the synchronization group. In the depicted example, this communication log includes a contact identifier 311, a type of communication used to communicate with the contact 312, a time of the last communication for that communication type 313, a duration of the last communication for that communication type 314, an identifier of whether a read receipt was returned 315 (used with text communication types), and an identifier of whether a response was received 316. Other information in addition to, or in replacement of, these information items may be used without departing from the spirit and scope of the present invention.

The contact identifiers 311 may be obtained from the contacts data structure 230 maintained by the communication devices of the synchronization group. The type of communication 312 may be determined based on the identity of the communication device and/or the identity of the communication type in the communication log of the particular communication device submitting the entry to the communication log data structure 310. Thus, for example, if a wireless telephone is submitting the communication log entry during a synchronization update process, then the communication type may be determined to be a telephone communication unless otherwise indicated by the wireless telephone.

The time of the communication 313 and duration 314 are preferably provided as part of the communication log entry submitted by the communication devices during the synchronization update process. Such information is typically maintained by communication logs of known communication devices.

The read receipt 315 entry is provided based on whether the particular communication device received a read receipt confirmation for a particular sent text communication. The response received 316 entry may be set based on a number of different types of characteristics based on the type of communication. For example, if it is determined that a telephone communication lasts longer than a threshold period of time, it can be assumed that the user is conversing with the contact and thus, a “response” is determined to have been received. Alternatively, if a user places a telephone communication to a contact that lasts less than a threshold period of time but thereafter receives a call from that contact within a set period of time of the original communication, then a response may be determined to have been received. Further, with text communications, if a text communication is received from the contact within a specified period of time of the original communication, then a response may be determined to have been received. Such determinations may be programmed into the communication monitor as various rules or the like.

The information maintained in the communication log data structure 310 is used to determine if a particular communication qualifies as a communication with the contact or merely an attempted communication. Based on the particular rules utilized, various combinations of information in the communication log data structure 310 are used as indicators of an actual communication or a communication attempt. For example, if the duration of the communication is below a predetermined threshold and a response is not received from that contact within a specified period of time from the time of the communication 313, then the communication may be determined to be a communication attempt rather than an actual communication. This affects whether or not to send a contact reminder message and add an entry to the user's “to do” list. If the communication is an actual communication, then it may not be necessary to send a contact reminder message or add an entry to the user's “to do” list. However, if the communication is merely an attempt, then such a contact reminder message and “to do” list entry may need to be provided to the user.

The generation of the contact reminder messages and “to do” list entries is performed based on the status of one or more contact reminder counters 330 generated based on the contact reminder preferences data structure 320 and the communication log data structure 310. Various contact reminder counters 334 and 336 may be generated for each contact 322 based on the contact reminder preferences data structure 320 and communication log data structure 310. For example, as shown in FIG. 3, John Smith has a first contact-reminder counter 334 for electronic mail communication and a second contact reminder counter 336 for telephone communication.

The contact reminder counters are generated based on the current time, the time interval specified by the user in the contact reminder preferences data structure 320, the time of the last communication of that particular communication type to the contact as specified in the communication log data structure 310, and any modifiers or weights applied based on the communication preferences specified by the user in the contact reminder preferences data structure 320. In the depicted example, since the last electronic mail communication with John Smith was on 11/30/05 at 10:00, the user wishes to communicate with John Smith at least every 30 days, and the current time is 12/24/05 10:00, the counter 334 for electronic mail communication with John Smith is currently at 8,640 minutes, i.e. 6 days. Thus, in 6 days, the 30 day interval between electronic mail communications will expire and a contact reminder message may be sent to the user.

Similarly, since the last telephone communication with John Smith was on 12/22/05 at 13:54, the user wishes to communicate with John Smith at least every 30 days, and the current time is 12/24/05 10:00, the counter 336 for telephone communications is currently at 40,554 minutes, i.e. 28.16 days. It should be noted that the telephone communication to John Smith in the communication log data structure 310 only lasted 1 minute and thus, would normally be determined to be merely a communication attempt and not an actual communication. However, since a response was received to this communication, the communication monitor may determine that an actual communication occurred and thus, this communication may be used to reset the counter 336.

It should further be noted that, in this example, since telephone communication is preferred with John Smith, and the user communicated with John Smith by telephone after communicating by electronic mail, the email counter 334 may be reset to be consistent with the telephone counter 336. This may be done so as to avoid sending a contact reminder message earlier than the 30 day interval specified by the user. However, if the email communication were made after the telephone communication, the email communication may not cause the telephone communication counter 336 to be reset to be consistent with the email counter 334 since email is not preferred. Alternatively, the subsequent email communication may be used to modify the email and telephone counters 334 and 336 according to a weighting scheme established based on the communication preferences set forth in the contact reminder preferences data structure 320, for example.

As a further example, as shown in FIG. 3, the user has established a time interval of 25 days for communicating with Bob Miller. Since the last communication with Bob Miller was on 11/23/05 at 11:04 and the current time is 12/24/05 10:00, more than 25 days have elapsed since the last communication with Bob Miller. As a result, the telephone counter 336 for Bob Miller is maintained at 0 and a contact reminder message and optional “to do” list entry are generated for reminding the user to communicate with Bob Miller. Such a contact reminder message may be output until the user communicates with Bob Miller. Similarly, the entry in the “to do” list may be maintained until the user communicates with Bob Miller. Once the communication with Bob Miller is made, the counter 336 may be updated and reset, the contact reminder message may be discontinued, and the “to do” list entry may be removed.

Thus, the illustrative embodiments provide a mechanism by which contact reminders may be generated based on user preferences for communication with contacts as well as communication logs from a plurality of different communication devices. Some illustrative embodiments allow for dynamic determination of contact reminder intervals based on a desired reminder interval, as specified by a user, previous communications with the contact, and established rules for adjusting contact reminder intervals. In some illustrative embodiments, the types of communications used to communicate with a contact are used to adjust the contact reminder intervals so as to promote preferred forms of communication as specified by a user.

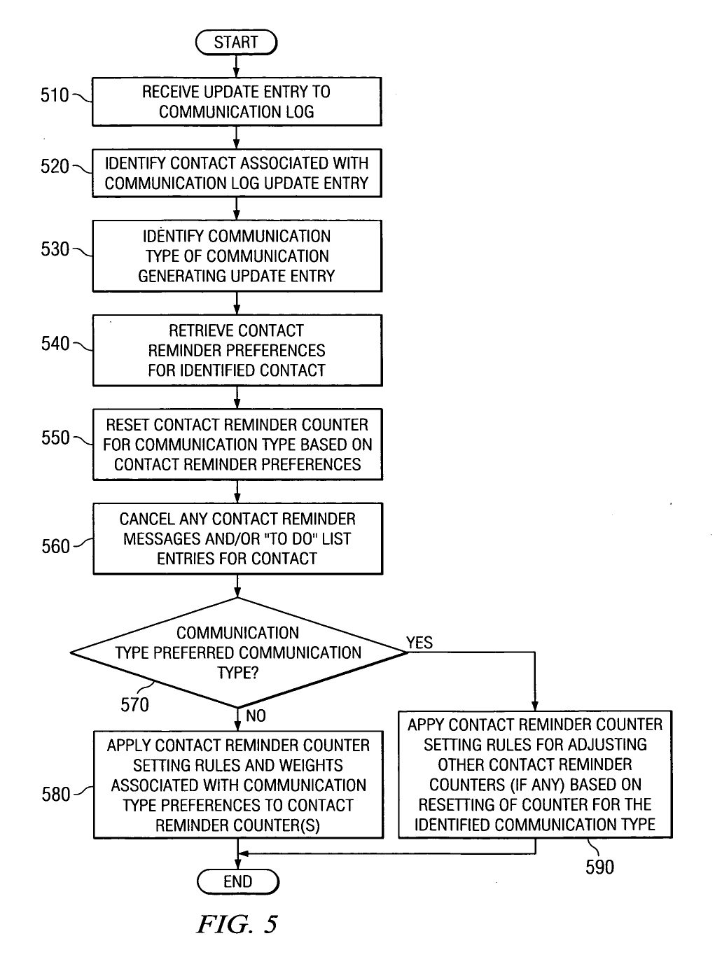

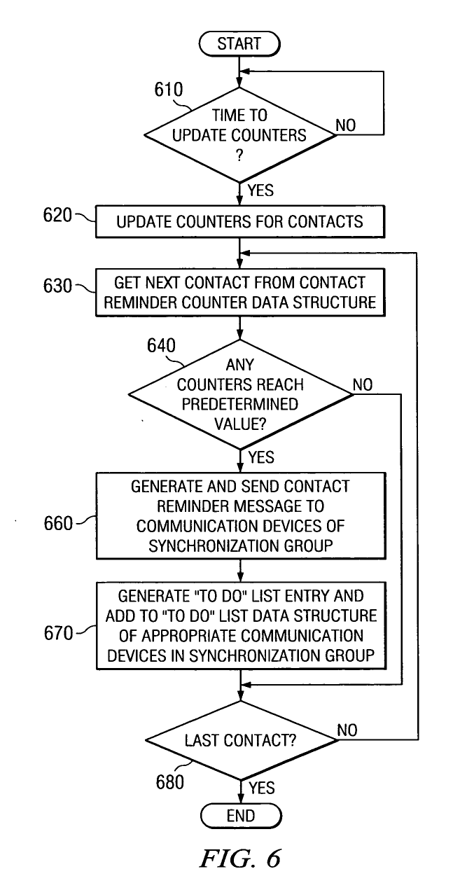

FIGS. 5-6 are flowcharts outlining exemplary operations of a communication monitor module in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

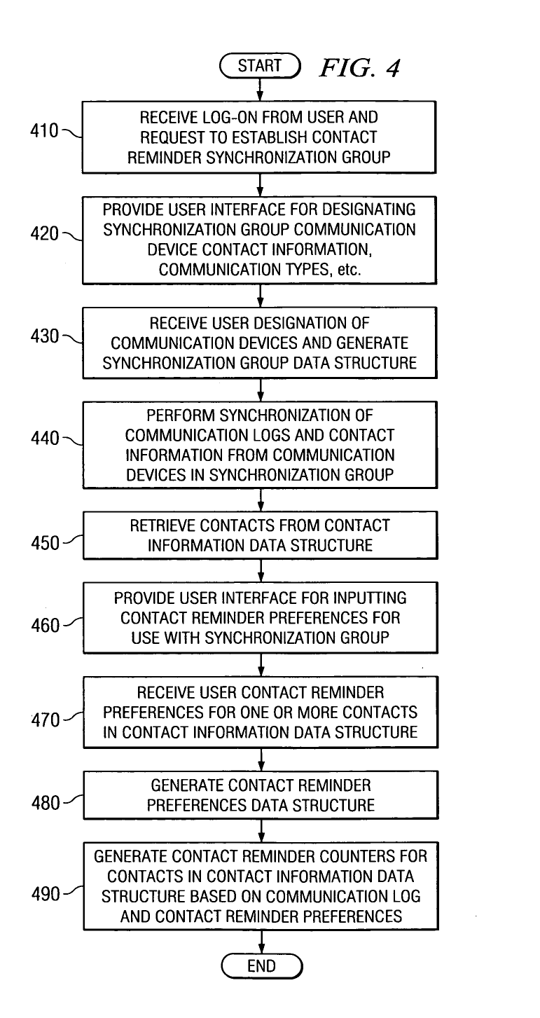

FIG. 4 is a flowchart outlining an exemplary operation of a communication monitor module for establishing a synchronization group and contact reminder preferences in accordance with one illustrative embodiment. As shown in FIG. 4, the operation starts with receiving a log-on from a user and a request to establish a contact reminder synchronization group (step 410). A user interface is provided to the user so that he/she may designate synchronization group communication device contact information, communication types, and other characteristics of the communication devices that are to be included in the synchronization group (step 420). This user interface, as well as other user interfaces described hereafter, may be provided, for example, by input/output interface module 226 in FIG. 2. This input/output interface module 226 may further receive the user's input via the user interface so that the input may be processed by the communication monitor module, for example.

The user's designation of communication devices to include in the synchronization group is received and the synchronization group data structure is generated based on the received information (step 430). The communication logs and contact information for the various communication devices specified as being part of the synchronization group are then synchronized (step 440).

The contacts for the synchronization group are then retrieved from a contact information data structure stored in the communication device in which the operation of FIG. 4 is being performed (step 450). A user interface is provided to the user for inputting contact reminder preferences for use with the synchronization group (step 460). The user contact reminder preferences are then received for one or more contacts in the contact information data structure (step 470). A contact reminder preferences data structure is generated (step. 480). One or more contact reminder counters for contacts in the contact information data structure are generated based on the communication log and contact reminder preferences (step 490). The operation then terminates.

FIG. 5 is a flowchart outlining an exemplary operation of a communication monitor module when updating a communication log and contact reminder counters in accordance with one illustrative embodiment. As shown in FIG. 5, the operation starts by receiving an update entry to a communication log (step 510). This update entry may be generated by the communication device in which the operation is being performed or from another communication device in a same synchronization group as the communication device in which the operation of FIG. 5 is being performed, for example.

The contact associated with the communication log update entry is identified (step 520) and the communication type of the communication that generated the update entry is identified (step 530). These items may be identified based on the information provided in the communication log update entry and/or an identity of the communication device submitting the update entry, for example.

The contact reminder preferences for the identified contact are retrieved (step 540) and the contact reminder counter for the communication type of the update entry is reset based on the contact reminder preferences (step 550). Any contact reminder messages and/or “to do” list entries corresponding to the identified contact are canceled (step 560).

A determination is made as to whether the communication type of the communication that generated the update entry is the preferred communication type for this contact (step 570). If not, contact reminder counter setting rules for promoting a preferred communication type, and weights associated with communication type preferences, are applied to the contact reminder counter(s) for this contact so as to emphasize the preference for a different communication type (step 580). Alternatively, if the communication type was a preferred communication type, then contact reminder counter setting rules, for adjusting other contact reminder counters (if any) associated with non-preferred communication types, based on the resetting of the counter for the identified communication type may be applied (step 590). The operation then terminates.

FIG. 6 is a flowchart outlining an exemplary operation of a communication monitor module when generating a contact reminder message and/or “to do” list entry in accordance with one illustrative embodiment. As shown in FIG. 6, the operation starts with a determination as to whether it is time to update the contact reminder counters (step 610). Counter updates may be performed continuously or periodically. If it is not time to update the contact reminder counters, then the operation loops back to step 610. Otherwise, if it is time to update the contact reminder counters, the contact reminder counters for all contacts of the synchronization group are updated (step 620).

A next contact in the contact reminder counter data structure is identified (step 630) and a determination is made as to whether any of the contact reminder counters for that contact have reached a predetermined value, e.g., 0 (step 640). If so, then a contact reminder message is generated and set to the communication devices of the synchronization group (step 660). A “to do” list entry may also, optionally, be generated and added to the “to do” list data structure of appropriate communication devices in the synchronization group (step 670).

Thereafter, or if none of the contact reminder counters have reached the predetermined value, then a determination is made as to whether this is the last contact in the contact reminder counter data structure (step 680). If it is not the last contact, then the operation returns to step 630 where the next contact is identified and the operation repeats. Otherwise, if this is the last contact in the contact reminder counter data structure, then the operation terminates.

Thus, the illustrative embodiments provide a mechanism for providing contact reminder messages to a user based on communications with contacts from a variety of different communication devices. The illustrative embodiments synchronize communication logs and contacts from communication devices of different types and use the synchronized communication logs to determine whether to reset contact reminder counters that are used to determine whether to send a contact reminder message to a user. Furthermore, a user may designate preferred types of communication for each contact and may have the contact reminder counters automatically adjusted based on such preferences and whether or not a preferred type of communication was last used to communicate with a contact.

As described above, the illustrative embodiments may take the form of an entirely hardware embodiment, an entirely software embodiment or an embodiment containing both hardware and software elements. In a preferred embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for sending contact reminder messages to one or more communication devices of a synchronization group, comprising:
establishing a synchronization group, wherein the synchronization group comprises at least two communication devices;
generating one or more contact reminder counters based on contact reminder preferences for the synchronization group; and
sending contact reminder messages to at least one communication device of the synchronization group in response to at least one of the one or more contact reminder counters reaching a predetermined value.

2. The method of claim 1, wherein a first communication device of the at least two communication devices communicates using a first communication type and a second communication device of the at least two communication devices communicates using a second communication type that is different from the first communication type.

3. The method of claim 1, further comprising:
generating a contact reminder preferences data structure for the synchronization group that comprises the contact reminder preferences for the synchronization group, wherein the contact reminder preferences data structure comprises, for each contact of a plurality of contacts, associated contact reminder preferences for generating contact reminders for that particular contact in the plurality of contacts.

4. The method of claim 3, wherein the contact reminder preferences specify at least one contact time interval for communicating with an associated contact and a preferred communication type for communicating with the associated contact.

5. The method of claim 4, wherein the contact reminder preferences specify at least one other communication type for communicating with the associated contact other than the preferred communication type.

6. The method of claim 5, wherein generating one or more contact reminder counters based on contact reminder preferences comprises generating, for the associated contact, two or more contact reminder counters based on the preferred communication type and the at least one other communication type.

7. The method of claim 1, wherein sending contact reminder messages to the at least one communication device of the synchronization group in response to at least one of the one or more contact reminder counters reaching a predetermined value comprises:
determining a communication type associated with a contact reminder counter that reached the predetermined value;
determining communication devices of the synchronization group providing communications using the determined communication type; and
sending contact reminder messages to communication devices of the synchronization group that provide communications using the determined communication type.

8. The method of claim 1, further comprising:
detecting initiation of a communication to a contact by a communication device in the synchronization group;
monitoring the communication to determine if a valid communication was conducted with the contact based on an application of one or more rules specifying criteria of a valid communication to characteristics of the monitored communication; and
resetting at least one of the one or more contact reminder counters to a value corresponding to a desired contact time interval for the contact, as specified in the contact reminder preferences, in response to the communication being determined to be a valid communication.

9. The method of claim 8, further comprising:
canceling contact reminder messages being output on communication devices of the synchronization group in response to the communication being determined to be a valid communication.

10. The method of claim 1, wherein sending contact reminder messages to the at least one communication device of the synchronization group in response to at least one of the one or more contact reminder counters reaching a predetermined value comprises:
checking the one or more contact reminder counters to determine if any one of the contact reminder counters reaches the predetermined value; and
sending a contact reminder message specifying a contact associated with a contact reminder counter that reached the predetermined value and a preferred communication type for communicating with the contact.

11. The method of claim 1, further comprising:
generating, for each contact reminder message, a “to do” list entry corresponding to the contact reminder message in at least one communication device of the synchronization group.

12. A computer program product comprising a computer useable medium having a computer readable program, wherein the computer readable program, when executed on a computing device, causes the computing device to:
establish a synchronization group, wherein the synchronization group comprises at least two communication devices;
generate one or more contact reminder counters based on contact reminder preferences for the synchronization group; and
send contact reminder messages to at least one communication device of the synchronization group in response to at least one of the one or more contact reminder counters reaching a predetermined value.

13. The computer program product of claim 12, wherein a first communication device of the at least two communication devices communicates using a first communication type and a second communication device of the at least two communication devices communicates using a second communication type that is different from the first communication type.

14. The computer program product of claim 12, wherein the computer readable program further causes the computing device to:
generate a contact reminder preferences data structure for the synchronization group that comprises the contact reminder preferences for the synchronization group, wherein the contact reminder preferences data structure comprises, for each contact of a plurality of contacts, associated contact reminder preferences for generating contact reminders for that particular contact in the plurality of contacts.

15. The computer program product of claim 14, wherein the contact reminder preferences specify at least one contact time interval for communicating with an associated contact and a preferred communication type for communicating with the associated contact.

16. The computer program product of claim 12, wherein the computer readable program causes the computing device to send contact reminder messages to the at least one communication device of the synchronization group in response to at least one of the one or more contact reminder counters reaching a predetermined value by:
determining a communication type associated with a contact reminder counter that reached the predetermined value;
determining communication devices of the synchronization group providing communications using the determined communication type; and
sending contact reminder messages to communication devices of the synchronization group that provide communications using the determined communication type.

17. The computer program product of claim 12, wherein the computer readable program further causes the computing device to:
detect initiation of a communication to a contact by a communication device in the synchronization group;
monitor the communication to determine if a valid communication was conducted with the contact based on an application of one or more rules specifying criteria of a valid communication to characteristics of the monitored communication; and
reset at least one of the one or more contact reminder counters to a value corresponding to a desired contact time interval for the contact, as specified in the contact reminder preferences, in response to the communication being determined to be a valid communication.

18. The computer program product of claim 17, wherein the computer readable program further causes the computing device to:
cancel contact reminder messages being output on communication devices of the synchronization group in response to the communication being determined to be a valid communication.

19. The computer program product of claim 12, wherein the computer readable program causes the computing device to sending contact reminder messages to the at least one communication device of the synchronization group in response to at least one of the one or more contact reminder counters reaching a predetermined value by:
checking the one or more contact reminder counters to determine if any one of the contact reminder counters reaches the predetermined value; and
sending a contact reminder message specifying a contact associated with a contact reminder counter that reached the predetermined value and a preferred communication type for communicating with the contact.

20. A communication apparatus, comprising:
a processor; and
a memory coupled to the processor, wherein the
memory contains instructions which, when executed by the processor, cause the processor to:
provide an interface for establishing a synchronization group, wherein the synchronization group comprises at least two communication devices;
generate one or more contact reminder counters based on contact reminder preferences for the synchronization group; and
send contact reminder messages to at least one communication device of the synchronization group in response to at least one of the one or more contact reminder counters reaching a predetermined value.
